(19) United States
(12) Patent Application Publication
(10) Pub. No.: US 2007/0211230 A1
(43) Pub. Date: Sep. 13, 2007

(54) BULB SORTING DEVICE AND SORTING METHOD THEREOF

(75) Inventors: HongNa Ning, Jiangsu Province (CN); XueGuang Huang, Jhe-jiang Province (CN)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ CORPORATION, Taoyuan Shien (TW)

(21) Appl. No.: 11/620,124

(22) Filed: Jan. 5, 2007

(30) Foreign Application Priority Data
Mar. 6, 2006 (TW) 95107462

(51) Int. Cl. G03B 21/00

(52) U.S. Cl. 353/122

(57) ABSTRACT

A bulb-sorting device is provided. The bulb-sorting device includes a positioning mechanism and a sensing element. The positioning mechanism is for fixing a bulb. The bulb has a first referred object and a second referred object. The first referred object and the second referred object are aligned along a referred axis. The sensing element is for catching a first image of the bulb. After the bulb is rotated by an angle relative to the referred axis, the sensing element captures a second image of the bulb. The first image is compared with the second image, so as to determine whether the bulb is qualified accordingly.

This application claims the benefit of Taiwan application Serial No. 95107462, filed Mar. 06, 2006, the subject matter of which is incorporated herein by reference.

### BACKGROUND OF THE INVENTION

1. Field of the Invention

The invention relates in general to a bulb-sorting device and a sorting method thereof, and more particularly to a projector bulb-sorting device and a sorting method thereof.

2. Description of the Related Art

Currently, the manufacturers of digital projector focus on bulb inspection on specifications such as lifespan and luminance, but the specification of brightness uniformity is not clearly specified yet. However, brightness uniformity is an important criterion in evaluating the performance of a projector. The luminance distribution of the bulb is the most important factor in determining the brightness uniformity of a projector. In order to improve the projection quality of a projector, the bulbs need to be sorted according to the brightness uniformity of the bulb so as to fit the needs of different projectors.

According to a conventional way of inspecting the brightness uniformity of a bulb, the bulb is turned on first, and then the bright spots of the bulb are projected on a detection plate such that the distribution of the light is detected next. Theoretically, the luminance distribution on the detection plate is a symmetric circle centered on the focal point, wherein the spot with largest luminance is referred as the hot spot. However, for the reflective mask and the electrode of the bulb manufactured in large batch, difference exists between the theoretical value and the actual value, and there are differences among the bulbs as well. These differences will affect the optical path and cause change to the luminance distribution, thereby affecting the brightness uniformity of the bulb as well as the quality of a projector. Conventionally, the brightness uniformity of the bulb is determined according to the distribution of the bright spots on the detection plate. However, according to the above bulb-sorting method, the bulb is repeatedly assembled, turned on, detected and dismounted, which is very time-consuming. Furthermore, after the bulb is turned on, it may occur that the bulb is burnt and can not be repaired.

### SUMMARY OF THE INVENTION

It is therefore an object of the invention to provide a bulb-sorting device capable of determining whether the bulb is qualified according to the image before and the image after the bulb is rotated by an angle without turning on the lamp and a sorting method thereof.

The invention achieves the above-identified object by providing a bulb-sorting device. The bulb-sorting device includes a positioning mechanism and a sensing element. The positioning mechanism is for fixing a bulb. The bulb has a first referred object and a second referred object. The first referred object and the second referred object are aligned along a referred axis. The sensing element is for catching a first image of the bulb. After the bulb is rotated by an angle relative to the referred axis, the sensing element captures a second image of the bulb. The first image is compared with the second image, so as to determine whether the bulb is qualified accordingly.

The invention achieves another object by providing a bulb sorting method, includes the following steps. First, a bulb having a first referred object and a second referred object is positioned, wherein the first referred object and the second referred object are aligned along a referred axis. Next, a first image of the bulb is captured. Then, the first image is recorded. Next, the bulb is rotated by an angle relative to the referred axis. Then, a second image of the bulb is captured. Next, the second image is recorded. Then, the first image is compared with the second image, so as to determine whether the bulb is qualified accordingly.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 shows a bulb-sorting device according to a preferred embodiment of the invention;

FIG. 2A and FIG. 2B respectively illustrate a perspective of a positioning mechanism and a bulb of FIG. 1 before and after the bulb is rotated;

FIG. 3 is a block diagram of a sensing element, a comparing unit, a display unit and a recording unit of bulb-sorting device of the invention;

FIG. 4 shows a bulb-sorting device and a linking body according to a preferred embodiment of the invention;

FIG. 5 is a flowchart of a bulb sorting method of the invention; and

FIGS. 6A˜6B are diagrams of image comparison according to the bulb sorting method of the invention.

### DETAILED DESCRIPTION OF THE INVENTION

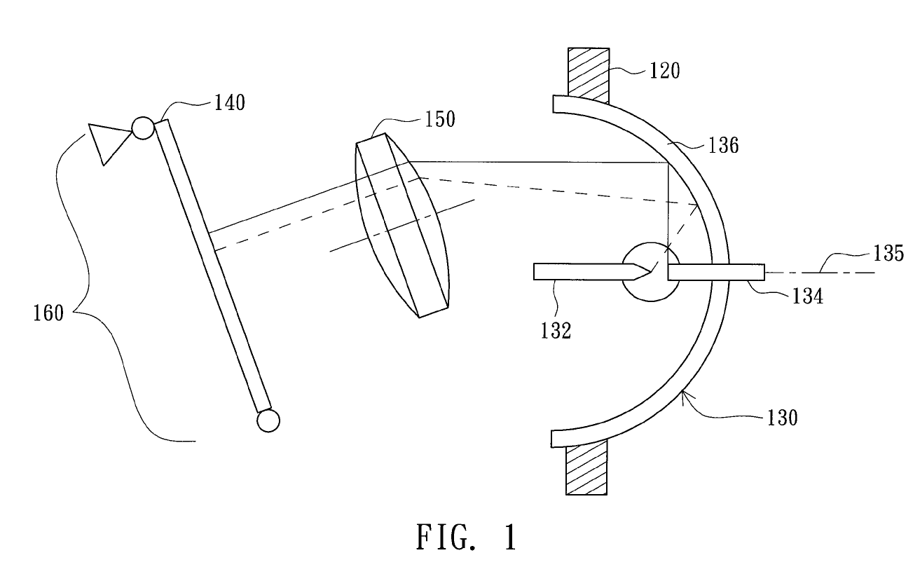

Referring to FIG. 1, a bulb-sorting device according to a preferred embodiment of the invention is shown. The bulb-sorting device includes a positioning mechanism 120 and a sensing element 140. The positioning mechanism 120 is for fixing a bulb 130 having a first referred object 132 and a second referred object 134. The first referred object 132 and the second referred object 134 are aligned along a referred axis 135. In the present embodiment of the invention, the first referred object 132 is a cathode of the bulb 130, the second referred object 134 is an anode of the bulb 130, and the bulb 130 is a reflective mercury-arc lamp. Examples of the sensing element 140 include charge coupled device (CCD), complementary metal oxide semiconductor (CMOS) sensing element, digital camera or digital video recorder.

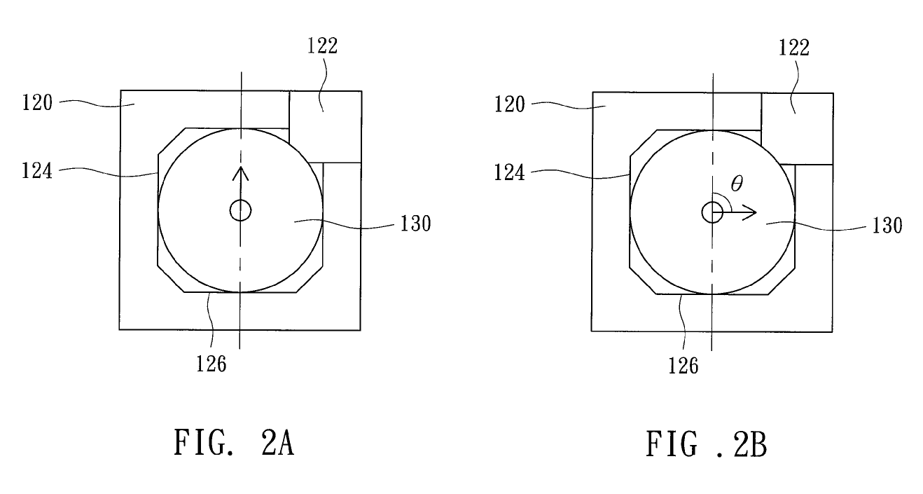

Referring to both FIG. 2A and FIG. 2B. FIG. 2A and FIG. 2B respectively illustrate a positioning mechanism and a bulb of FIG. 1 before and after the bulb is rotated. As indicated in FIG. 2A, the positioning mechanism 120 has a bump 122. The positioning mechanism 120 presses the bulb 130 against the datum planes 124 and 126 by the bump 122 to fix the bulb 130. After the sensing element 140 captures a first image of the bulb 130, the bulb 130 is rotated by an angle 0 relative to the referred axis 135 as indicated in FIG. 2B. Next, a second image of the bulb 130 is captured by the sensing element 140. A determination as to whether the bulb 130 is qualified is made by comparing the first image with the second image. In the present embodiment of the invention, the angle θ is preferably 90 degrees.

The bulb 130 is rotated relative to the referred axis 135 formed along the first referred object 132 (such as a cathode) and the second referred object 134 (such as an anode). If the bulb 130 is determined to be qualified, this implies that the relative position and distance between the first referred object 132 (such as a cathode) and the second referred object 134 (such as an anode) should be fixed. No matter how large an angle the bulb 130 is rotated by relative to the referred axis 135, the relative position and distance of the image of the second referred object 134 (such as an anode) in the first image and that in the second image should be fixed. If the relative position and distance of the image of the second referred object 134 (such as an anode) in the first image and that in the second image are the same, the bulb 130 is determined to be qualified. If the relative position and distance of the image of the second referred object 134 (such as an anode) in the first image and that in the second image are not the same, the bulb 130 is determined to be unqualified.

Besides, the bulb 130 further includes a reflective mask 136. The referred axis 135 is substantially parallel to a reflective central axis of the reflective mask 136. The opening of the reflective mask 136 is toward the sensing element 140. The sensing element 140 captures the first image and the second image of the bulb 130 by the reflective mask 136. The reflective mask 136 can have a parabolic reflective surface or a semi-elliptical reflective surface. According to the imaging theory, the reflective mask 136 is used as an imaging element, the first referred object 132 and the second referred object 134 are imaged on the sensing element 140 by the reflective mask 136. When defects occur to the reflective mask 136 or to the first referred object 132 and the second referred object 134 during manufacturing, both the position and shape of the image will be affected. That is, the image reflects the overall characteristics of the bulb 130 no matter good or bad, thus each of the bulbs can be sorted without being turned on.

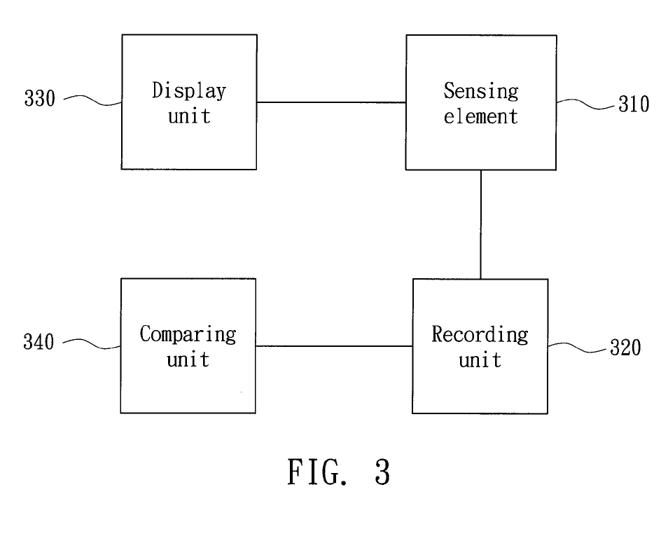

Referring to FIG. 3, a block diagram of a sensing element, a comparing unit, a display unit and a recording unit of bulb-sorting device of the invention is shown. The bulb-sorting device further includes a comparing unit 340 electrically connected to the sensing element 310. The comparing unit 340 is for comparing the first image with the second image so as to determine whether the bulb 130 is qualified. Furthermore, the bulb-sorting device further includes a display unit 330 electrically connected to the sensing element 310. The display unit 330 is for displaying the first image and the second image for a user to compare and determine whether the bulb 130 is qualified. Examples of the display unit 330 include a monitor. Examples of the comparing unit 340 include a comparing system of a comparing program executed on a computer. The user can fix the position of a referred object in the first image as a datum point, (for example, the first referred object 132 is used as a datum point), and records the coordinate of the second referred object 134 at the same time. Next, the position of the first referred object 132 in the second image is fixed, and the coordinate of the second referred object 134 is recorded at the same time. The shift of the second referred object 134 after the bulb 130 is rotated by an angle can be determined according to the comparison between the two coordinates. If the shift is smaller than an upper limit, the bulb 130 is determined to be qualified; and if the shift is larger than or equal to the above upper limit, the bulb 130 is determined to be unqualified. Or, if the shift is smaller than or equal to the above-mentioned upper limit, the bulb 130 is determined to be qualified; and if the shift is larger than the above upper limit, the bulb 130 is determined to be unqualified.

As indicated in FIG. 3, the bulb-sorting device further includes a recording unit 320. The sensing element 310 is electrically connected to the recording unit 320 and the display unit 330 respectively. Thus, the sensing element 310 can capture and transmit the first image and the second image to be recorded in the recording unit 320 first, and then the first image and the second image are transmited to the comparing unit 340 for comparison next. Alternatively, the sensing element 310 can display the first image and the second image on the display unit 330 for a user to compare. The comparing unit 340 determines whether the bulb 130 is qualified according to whether the difference between the first distance in the first image and the second distance in the second image is smaller than a tolerance, wherein the first distance and the second distance are between the first referred object 132 and the second referred object 134. The inspector can set an upper limit to the tolerance. If the difference is smaller than the above-mentioned tolerance, the bulb 130 is determined to be qualified; and if the difference is larger than or equal to the above tolerance, the bulb 130 is determined to be unqualified. Or, if the difference is smaller than or equal to tolerance, the bulb 130 is determined to be qualified; and if the difference is larger than the above tolerance, the bulb 130 is determined to be unqualified. The positioning mechanism 120 of the present embodiment of the invention is exemplified by the bump 122 and the datum planes 124 and 126. However, the positioning mechanism 120 can be designed to be any retaining mechanism or engaging mechanism.

Besides, the bulb-sorting device 100 further includes a lens module 150 disposed between the bulb 130 and the sensing element 140. The sensing element 140 enlarges and shortens an optical path and captures the first image and the second image by the lens module 150. In the present embodiment of the invention, the lens module 150 is a convex lens, and is used to enlarge and shorten the optical path, such that the overall size of the bulb-sorting device 100 is reduced, and the image is enlarged to facilitate inspection. The positioning mechanism 120, the sensing element 140, and the lens module 150 can be correspondingly disposed on a linking body.

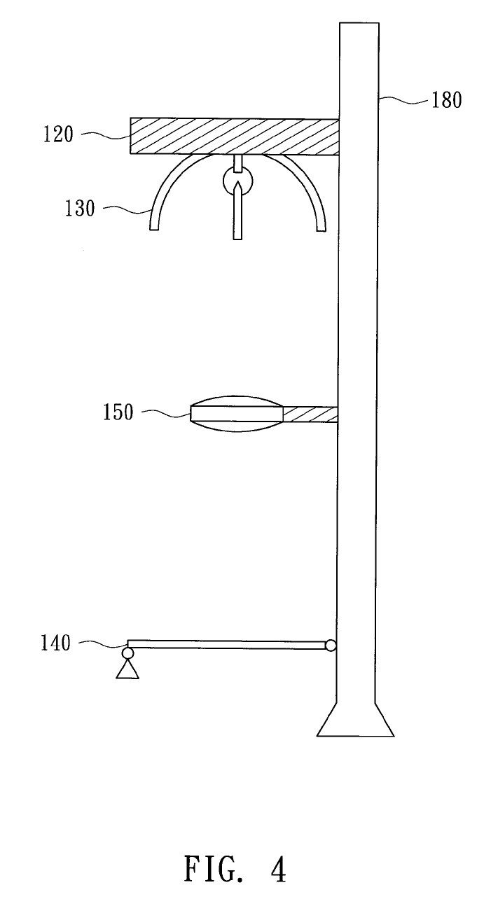

Referring to FIG. 4, a bulb-sorting device and a linking body according to a preferred embodiment of the invention is shown. The positioning mechanism 120 is disposed at the top of the body 180, the sensing element 140 is disposed at the bottom of the body 180, and the lens module 150 is disposed on the body 180 but is located between the bulb 130 and the sensing element 140.

Besides, the bulb-sorting device 100 further includes an adjusting mechanism 160 for adjusting the sensing element 140, such that the sensing element 140 can capture the first image and the second image of the bulb 130 with high image quality.

When the bulb 130 is fixed on the datum planes 124 and 126 of FIG. 2A, the sensing element 140, the contained angle between the lens module 150 and the bulb 130, and the distance between the lens module 150 and the sensing element 140 are adjusted. When a clear and enlarged image of the first referred object 132 (such as a cathode) and the second referred object 134 (such as an anode) of the bulb 130 is captured, the sensing element 140 and the lens module 150 are fixed. After that, the bulb is rotated by 90 degrees at least twice. After two times of imaging, the overall characteristics of the reflective mask 136 and the first referred object 132 (such as a cathode) and the second referred object 134 (such as an anode) are reflected.

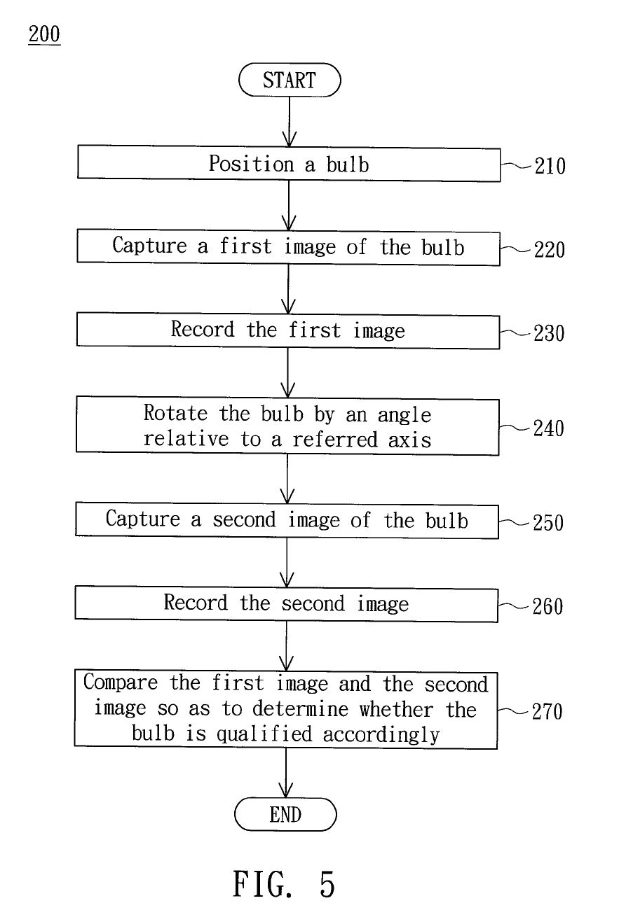

Referring to FIG. 5, a flowchart of a bulb sorting method of the invention is shown and is exemplified by the bulb-sorting device of FIG. 1. The bulb sorting method 200 includes the following steps. First, the method begins at step 210, the bulb 130 is positioned. Of the bulb-sorting device, the bulb 130 has a first referred object 132 and a second referred object 134, wherein the first referred object 132 and the second referred object 134 are aligned along a referred axis 135. The first referred object 132 is a cathode, and the second referred object 134 is an anode.

Next, the method proceeds to step 220, a first image of the bulb 130 is captured.

Then, the method proceeds to step 230, the first image is recorded.

Next, the method proceeds to step 240, the bulb 130 is rotated by an angle relative to the referred axis 135. The angle is preferably equal to 90 degrees.

Then, the method proceeds to step 250, a second image of the bulb 130 is captured.

Next, the method proceeds to step 260, the second image is recorded.

Then, the method proceeds to step 270, the first image is compared with the second image so as to determine whether the bulb 130 is qualified.

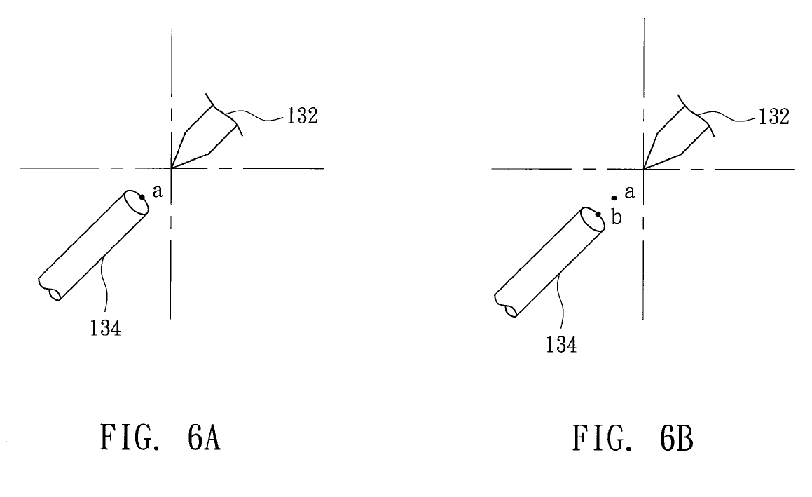

However, anyone who is skilled in the technology of the present embodiment of the invention will understand that the scope of technology of the bulb sorting method 200 of the present embodiment of the invention is not limited thereto. For example, step 270 can further include a sub-step of determining whether the bulb 130 is qualified according to whether the difference between the first distance in the first image and the second distance in the second image is smaller than a tolerance, wherein the first distance and the second distance are located between the first referred object 132 and the second referred object 134. If the shift is smaller than or equal to the upper limit of the tolerance, the bulb 130 is determined to be qualified. Referring to FIGS. 6A˜6B, diagrams of image comparison according to the bulb sorting method of the invention are shown. As indicated in FIG. 6A, first, the tip of the image of the first referred object 132 is aligned with the original point of the coordinate, and the coordinate of a point “a” located in the front of the image of the second referred object 134 is recorded. Next, as indicated in FIG. 6B, the bulb 130 is rotated first, and the tip of the image of the first referred object 132 is aligned with the original point of the coordinate, and the coordinate of a point “b” located in the front of the image of the second referred object 134 is recorded. The shift of the second referred object 134 is obtained according to the coordinates of the pints “a” and “b”. Then, the shift is compared with the tolerance so as to determine whether the bulb 130 is qualified.

Moreover, step 270 can further include a sub-step of displaying the first image and the second image for a user to compare and determine whether the bulb 130 is qualified. The user can fix the position of a referred object in the first image as a datum point, (for example, the first referred object 132 is used as a datum point), and records the coordinate of the second referred object 134 at the same time. Next, the position of the first referred object 132 in the second image is fixed as a datum point, and the coordinate of the second referred object 134 is recorded at the same time. The shift of the second referred object 134 after the bulb 130 is rotated by an angle can be determined according to the comparison of the two coordinates. If the shift is smaller than an upper limit, the bulb 130 is determined to be qualified; and if the shift is larger than or equal to the above-mentioned upper limit, the bulb 130 is determined to be unqualified. Or, the user can view to check whether the relative position and distance of an image of the second referred object 134 (such as an anode) in the first image are the same with that in the second image, so as to determine whether the bulb 130 is qualified.

Furthermore, the step 220 can further include a sub-step of capturing the first image of the bulb 130 by a reflective mask 136 of the bulb 130. The referred axis 135 is substantially parallel to a reflective central axis of the reflective mask 136.

The step 250 can further include a sub-step of capturing the second image of the bulb 130 by the reflective mask 136.

Furthermore, the bulb sorting method 200 can further include the following steps. The image of the first referred object 132 in the first image is aligned with a reference coordinate. Next, a first coordinate of the second referred object 134 is recorded. Then, following step 240, the image of the first referred object 132 in the second image is aligned with the reference coordinate. Next, a second coordinate of the second referred object 134 is recorded. Then, the first coordinate is compared with the second coordinate, so as to determine whether the bulb is qualified accordingly.

The above-mentioned step of comparing the first image with the second image can further include the following sub-steps. The shift between the first coordinate and the second coordinate is obtained according to the first coordinate and the second coordinate. Then, whether the shift is smaller than an upper limit is determined, so as to determine whether the bulb is qualified accordingly.

According to the bulb-sorting device disclosed in the above embodiment of the invention and the sorting method thereof, whether the bulb is qualified is determined without turning on the lamp according to the comparison between the image before and the iamge after the bulb is rotated by an angle. The invention can promptly sort the bulb, effectively saving the labor for inspecting. Furthermore, the bulb will not be burnt, thereby avoiding additional loss. The bulb-sorting device is very simple and includes only a sensing element and a positioning mechanism. The sorting of the bulb is contributive to the brightness uniformity of a projected image, and also increases the pass-rate in the production line. Sorting by comparing the images is less interfered with by human factors, and the obtained results are more objective and reliable. Moreover, through image comparison, whether the cathode and the anode of the bulb are cracked or adhered by mercury can be detected. The sorting method is very practical and can be used in input quality control (IQC) or double-check of work.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A bulb-sorting device, comprising:
a positioning mechanism for fixing a bulb, wherein the bulb has a first referred object and a second referred object, and the first referred object and the second referred object are aligned along a referred axis; and
a sensing element for catching a first image of the bulb;
wherein after the bulb is rotated by an angle relative to the referred axis, then the sensing element captures a second image of the bulb, and whether the bulb is qualified is determined by comparing the first image with the second image.

2. The device according to claim 1, further comprising a comparing unit for comparing the first image with the second image so to determine whether the bulb is qualified.

3. The device according to claim 1, wherein whether the bulb is qualified is determined according to whether the difference between a first distance and a second distance is smaller than a tolerance, wherein the first distance is the distance between the first referred object and the second referred object in the first image, and the second distance is the distance between the first referred object and the second referred object in the second image.

4. The device according to claim 1, further comprising a display unit for displaying the first image and the second image for a user to compare.

5. The device according to claim 1, further comprising a lens module disposed between the bulb and the sensing element, wherein the sensing element enlarges and shortens an optical path and captures the first image and the second image by the lens module.

6. The device according to claim 1, wherein the bulb further comprising a reflective mask, the referred axis is substantially parallel to a reflective central axis of the reflective mask, the opening of the reflective mask is toward the sensing element, the sensing element captures the first image and the second image of the bulb by the reflective mask.

7. The device according to claim 6, wherein the reflective mask has a parabolic reflective surface or a semi-elliptical reflective surface.

8. The device according to claim 1, further comprising an adjusting mechanism for adjusting and enabling the sensing element to capture the first image and the second image of the bulb.

9. The device according to claim 1, wherein the sensing element is a charge coupled device (CCD), a complementary metal oxide semiconductor (CMOS) sensing element, a digital camera or a digital video recorder.

10. The device according to claim 1, wherein the first referred object is a cathode, and the second referred object is an anode.

11. The device according to claim 1, further comprising a recording unit for recording the first image and the second image for comparison.

12. The device according to claim 1, wherein the angle is substantially equal to 90 degrees.

13. A bulb sorting method, comprising:
positioning a bulb having a first referred object and a second referred object, wherein the first referred object and the second referred object are aligned along a referred axis;
capturing the first image of the bulb;
rotating the bulb by an angle relative to the referred axis;
capturing the second image of the bulb; and
comparing the first image and the second image so as to determine whether the bulb is qualified accordingly.

14. The sorting method according to claim 13, wherein the step of determining whether the bulb is qualified further comprises:
determining whether the bulb is qualified according to whether a difference between a first distance and a second distance is smaller than a tolerance, wherein the first distance is the distance between the first referred object and the second referred object in the first image, and the second distance is the distance between the first referred object and the second referred object in the second image.

15. The sorting method according to claim 13, wherein the step of determining whether the bulb is qualified further comprising:
displaying the first image and the second image for a user to compare and determine whether the bulb is qualified.

16. The sorting method according to claim 13, wherein the step of capturing the first image of the bulb further comprising:
capturing the first image of the bulb by a reflective mask of the bulb, wherein the referred axis is substantially parallel to a reflective central axis of the reflective mask.

17. The sorting method according to claim 16, wherein the step of capturing the first image of the bulb further comprising:
capturing the second image of the bulb by the reflective mask.

18. The sorting method according to claim 13, further comprising:
aligning the image of the first referred object in the first image along a reference coordinate;
recording a first coordinate of the second referred object;
aligning the image of the first referred object in the second image with the reference coordinate;
recording the second coordinate of the second referred object; and
comparing the first coordinate and the second coordinate so as to determine whether the bulb is qualified accordingly.

19. The sorting method according to claim 18, wherein the step of determining whether the bulb is qualified further comprising:
obtaining a shift between the first coordinate and the second coordinate according to the first coordinate and the second coordinate; and
determining whether the shift is smaller than an upper limit so as to determine whether the bulb is qualified accordingly.
